(19) United States
(12) Patent Application Publication
(10) Pub. No.: US 2013/0041621 A1
(43) Pub. Date: Feb. 14, 2013

(54) VEHICLE SPEED, FUEL, AND REVENUE OPTIMIZER

(71) Applicants: David B. Smith, Monroe, MI (US); Michael D. Smith, Farwell, MI (US)

(72) Inventors: David B. Smith, Monroe, MI (US); Michael D. Smith, Farwell, MI (US)

(21) Appl. No.: 13/588,333

(22) Filed: Aug. 17, 2012

Related U.S. Application Data
(63) Continuation-in-part of application No. 13/552,203, filed on Jul. 18, 2012.
(60) Provisional application No. 61/572,575, filed on Jul. 18, 2011.

(51) Int. Cl. G06F 17/18; G06F 11/30

(52) U.S. Cl. 702/142

(57) ABSTRACT

Apparatus and methods are used to sense powered vehicle operating conditions, and compute and display to the operator the instant, most advantageous or optimum speed for conditions based on variable and fixed costs for that particular vehicle. Instead of the conventional or traditional display of fuel consumption relative to distance, the invention computes and displays the speed at which all cost factors result in optimal utilization of resources. If adhered to by the operator, either manually or through direct interface with vehicle speed control, this speed will provide the best balance between distance traveled per unit time with minimum negative impact from fixed and operating costs, resulting in minimum overall operating cost as well as maximum profit potential for the commercial operator. In addition, waste of valuable and limited-supply fossil fuel is minimized by encouraging avoidance of excessive speeds that waste fuel.

### REFERENCE TO RELATED APPLICATION

This application is a continuation-in-part of U.S. patent application Ser. No. 13/552,203, filed Jul. 18, 2012, which claims priority from U.S. Provisional Patent Application Ser. No. 61/572,575, filed Jul. 18, 2011, the entire content of both of which is incorporated herein by reference.

### FIELD OF THE INVENTION

This invention broadly resides in apparatus and methods to sense powered vehicle operating conditions, and, in particular, to apparatus and methods to compute and display the most advantageous or optimum speed based on variable and fixed costs for that particular vehicle.

### BACKGROUND OF THE INVENTION

Since the inception of powered vehicles, there has been a desire to reduce cost of operation, fossil fuel or other energy consumption, as well as emissions of pollutants and greenhouse gases from automobiles, buses, trucks, trains, boats and aircraft powered by internal or external combustion engines (ICE and ECE) and other prime movers such as electric motors. Over the last two centuries, many inventions have served to improve the fuel consumption of automobiles and trucks and other powered vehicles and save precious fossil fuels. For examples, high pressure/temperature, steam and high compression engines, multi-speed and overdrive transmissions, improved aerodynamics, radial tires, electronic fuel injection, electronic engine and power train controls, lighter but stronger materials and improved methods of construction have all contributed to the efficacy of modern vehicles. The introduction and commercialization of hybrid vehicles with the capability to store energy through regenerative braking and reuse the energy during acceleration have demonstrated some dramatic improvements in fuel mileage and, with the advent of fully electric vehicles, total independence from fossil fuel carriage.

The total energy consumed by a vehicle depends on the distance traveled, the basic vehicle design and payload carried, but energy consumption is also significantly dependent on how the vehicle is operated. For example, every passenger car and light truck for sale in the U.S. has a window sticker displaying the estimated mileage (miles per gallon) based on standard “urban” as well as “highway” test cycles. These simple yardsticks of efficiency, though suitable as input to a purchase decision, leave much to be desired as an aid to operating a vehicle in a fuel- and time-efficient manner.

Like all else in the physical world, tradeoffs exist between fuel or other energy economy, time en route, vehicle wear and vehicle availability for other purposes. While driving at the highest permitted speed will result in the minimum time en route, energy and vehicle wear costs will be at a maximum. Driving at a speed that provides the greatest distance traveled per unit of energy will minimize energy and vehicle wear costs, but may be at the expense of valuable time and other cost factors, including revenue, labor, insurance, debt service and taxes.

Since the early days of the automobile, “experts” have given advice to operators on ways to reduce fuel consumption, and often to the experts' chagrin, such advice is mostly ignored. The most oft-repeated advice to save fuel is to drive and accelerate more slowly. This same advice can be seen today on the EPA and other websites. This idea led to the national speed limit of 55 mph, enacted by Congress in 1974 following the Arab oil embargo. Although this law was repealed in the mid-1990s, the policies of many trucking fleets continue to limit over-the-road operators to 62 mph or other speed to conserve fuel.

Many systems have been marketed to operators of vehicles with the aim or claim to reduce fuel consumption and cost, and some may actually work. One of perhaps the earliest, most simple and inexpensive devices for automobiles is the intake manifold vacuum gauge. Operators were advised to not operate the engine at low manifold vacuum, i.e., large throttle openings, and the instrument often had green, yellow, and red ranges. Such a device was interesting for a while, but it was soon seen as arbitrary and abstract.

The next step in technology was a variety of mechanical devices designed to display to the operator an indication of the fuel consumed per distance traveled, in miles per gallon of fuel, liters per 100 kilometers, or simply mileage. Patent records reveal such devices from the 1920s or earlier to nearly present day.

Developments in emissions regulations, solid state electronics, microprocessors, and electronic engine controls have provided additional sensors and means of obtaining speed, fuel flow, and other information from vehicles, and means to compute and display information to operators. For example, displays of actual instantaneous miles per gallon (mileage) or liters per 100 kilometer became available factory installed on many vehicles as well as the aftermarket in the form of “trip computers.” For instance, U.S. Pat. No. 3,983,533 to Goszyk et al. used analog electronic devices to produce such a display with a warning device. U.S. Pat. No. 4,050,295 to Harvey described a digital electronic measuring system. U.S. Pat. No. 4,287,503 to Sumida provides a “running data central display arrangement for motor vehicles and the like” for abnormal conditions as well as selected running conditions, including “average fuel cost” but fails to define what is meant or how it is calculated.

The method and device of Barske in U.S. Pat. No. 4,590,568 determines a rate of fuel consumption and controls the vehicle engine to achieve a desired distance for a given quantity of fuel. U.S. Pat. No. 4,593,357 of Van Ostrand, et al. describes a portable computer based performance monitoring system with an improved fuel flow meter and a display of mileage. U.S. Pat. No. 4,706,083 to Baatz, et al. describes an improved fuel flow meter to determine and display a “performance ratio.”

U.S. Pat. No. 6,411,888 to Weisman, II describes a driving efficiency gauge and display, wherein a measure is derived and displayed by a calculation of losses of braking and idling, and calculating the cost of operating a vehicle per unit distance traveled or per unit of time, and an instantaneous braking velocity cost per unit distance. Although these calculations may have merit to individual drivers and fleet operators, it seems abstract and only measures part of the complete driving cycle.

U.S. Pat. No. 6,694,245 to Kinami, et al. describes another method to calculate fuel flow based on the measure of air flow and fuel to air ratio. He then uses this information to calculate and display measures such as “excess drive force,” “reserve drive force,” a “hard braking/hard acceleration warning lamp,” and average fuel consumption rate. Histograms of same also recorded in the data processor. His fuel flow measure may be valid but seems obvious. The definition or threshold of “excess drive force,” “hard braking/acceleration,” etc. has to be by definition made by an “expert,” thus to an operator becomes another arbitrary and capricious measure.

U.S. Pat. No. 6,975,217 to Endoh describes another vehicle fuel mileage meter which displays the mileage after a vehicle has exceeded a predetermined threshold speed. Such information may make good advertising claims for manufacturers, but neglects a significant part of the real world driving experience.

U.S. Pat. No. 6,988,033 to Lowery, et al. describes using the vehicle On-Board Diagnostics (OBD) systems, wireless data transmission, and the Internet to determine a vehicle's fuel efficiency. This document describes another system for obtaining vehicle speed, Mass Air Flow (MAF) and/or percent engine load and other data from the OBD port, calculating fuel flow, sending the data over wireless data and/or cell phone systems to the Internet and a host computer. The host computer is used to determine properties of the vehicle such as tire pressure, status of the fuel injection system, etc. The average fuel mileage and amount of money spent on fuel is calculated and relayed back to the vehicle operator. The system may be of benefit to vehicle manufacturers or fleet operators, but seems to us not to merit the complexity of the system to a vehicle owner.

U.S. Pat. No. 6,694,806 to Kumagi, et al. describes another method to calculate fuel flow based on engine rotation speed and accelerator depression and looking up BSFC on an engine performance map. He then uses this information to compute, display, and record fuel mileage over several different operating conditions of the vehicle, i.e. another mileage meter.

U.S. Pat. No. 7,024,319 to George describes an apparatus and method for fuel measurement and accountability for vehicles such as a boat, truck, or automobile, providing measure and accounting of fuel purchase and burn. Additionally, this patent describes accumulating speed and fuel burn rate data and fitting to a graph using least-squares calculation. The reference then describes “best fuel economy” as the point of maximum slope on the graph, and “best velocity” as the point of zero slope on the graph. However, the question arises, “Best for what?” The “best fuel economy” may be technically correct, but ignores any commercial or practical aspects of operation, such as delivering a cargo on time or any financial considerations such as making money. His “best velocity” point is where any additional fuel burn or power yields no increase in speed (hull speed limit?), which hardly seems “best” and more like “worst.” Consequently, these computations seem to have no practical or commercial value.

U.S. Pat. No. 7,072,762 to Minami, et al. describes another evaluation system for vehicles, summarizing fuel consumed during operations that worsen fuel economy such as acceleration. The document fails to describe how to accelerate a vehicle without consuming more fuel than required at a steady speed, nor the consequences of different rates of acceleration.

U.S. Pat. No. 7,603,228 to Coughlin describes a “haptic” (sense of touch) device to vibrate the accelerator pedal when an aspect of vehicle operation crosses a speed or acceleration threshold. The patent indicates a possible message “could include . . . the money saved per hour like a wage being earned through better driving habits,” but does not describe how to implement such a feature. Several higher cost modes of vehicle operation are described and when thresholds are exceeded the vibration is initiated. As with other referenced devices, the thresholds are set by the expert, whoever that is and using what unknown criteria.

U.S. Pat. No. 7,983,807 to Skaff et al. describes a “System and Method for Displaying Vehicle Efficiency”, and is in wide scale application on one manufacturer's hybrid vehicles. The system accumulates fuel and energy used to propel the vehicle over a distance, and periodically calculates the current energy used compared to past use, and then updates a display of varying numbers of “leaves” to indicate an improvement or worsening of energy efficiency. An additional calculation of the amount of currency saved per distance may also be displayed, shown in dollars or other currency. Such a display shows changes in drivers' habits and efficiency over time, but fails to specifically identify actions that either save or waste fuel; it is equivalent to a mpg meter that compares recent mpg to past mpg and indicates better or worse performance. The “fuel saved” calculation in dollars may be interesting and useful, but the device provides no guidance for changing the number and sustaining a saving behavior.

US Patent Application Publication 2010/0178637 to Lecointre et al. describes an “Interactive system for helping the driver of a motor vehicle to adopt an economical driving style . . . ”. The device seeks to identify economic and wasteful driving styles and inform the driver of “improvable techniques”. This device goes beyond the traditional measuring and monitoring devices, seeking to identify actual waste and improvable scenarios, counting wasteful operations, and then providing advice. It seems like a worthwhile concept, but relies on identification of improvable scenarios by an expert or some unexplained algorithm, and “improvable scenarios” remain undefined.

Information from the any or all of above displays may at first be interesting to operators, but we found these data fail to provide guidance sufficient to optimally operate the vehicle during all modes normally encountered. How does one determine throttle position to provide most efficient operation? Will lowered speed and energy consumption result in worthwhile savings or will time lost en route increase net cost due to other factors that offset energy cost savings? Will increased average speed and corresponding increase in energy consumption be offset by increased miles traveled and revenue, with a corresponding decrease in fixed cost contribution?

Additional devices have been developed to guide vehicle operators to operate the vehicle in more fuel efficient ways, such as upshift indicators or devices to signal the operator that operation exceeds an arbitrary value. Such devices provide advice like a parent or policeman, so often become mere annoyances, like the seat belt warning buzzer of the 1970s.

Considering a machine or method to include the impact on time of travel, some devices above describe calculating average operating cost of a vehicle per hour. However, such a measure is not very useful; for example, how many people would choose to fly if they calculated the cost of a $400, 4 hour cross-country flight at $100/hr? A better analysis is to consider and compare the alternatives, such as the cost and time of flying compared to a 4 day automobile trip.

Prior art approaches tend to ignore financial parameters germane to optimization of vehicle resources; namely, operating costs including energy, maintenance, consumables including tires, lubricants and brake linings, fixed costs including debt service, insurance and taxes, duty day, required time of arrival and labor costs that vary as a function of vehicle speed. When these financial factors are considered, basic fuel efficiency data may not necessarily reflect the most effective use of resources.

Despite a century or so of expert opinion and exhortation to drive slower, speeds continue to increase, and traffic fatalities continue to decrease. Perhaps motorists are interested in more than saving fuel; other factors come into play, such as overall use of resources including vehicles, roadways, and time. Simply put, the prior art generally fails to consider what most individuals and businesses value most after their safety, and that is in fact, time and money.

### SUMMARY OF THE INVENTION

This invention broadly resides in apparatus and methods to sense powered vehicle operating conditions, and compute and display to the operator the instant, most advantageous or optimum speed for conditions based on variable and fixed costs for that particular vehicle. Instead of the conventional or traditional display of fuel consumption relative to distance, the invention computes and displays the speed at which all cost factors result in optimal utilization of resources. If adhered to by the operator, either manually or through direct interface with vehicle speed control, this speed will provide the best balance between distance traveled per unit time with minimum negative impact from fixed and operating costs, resulting in minimum overall operating cost as well as maximum profit potential for the commercial operator.

The preferred embodiment senses powered vehicle operating conditions, and computes and displays to the operator the speed that would result in optimized vehicle resources; herein referred to as the optimum speed. The optimum speed may optionally be input to the vehicle cruise control, automatic speed control, autopilot or other vehicle management system. Vehicle resources include such parameters as revenue, vehicle capital cost, operating costs such fuel, maintenance, driver labor cost. The goal is to determine and display the optimum speed that maximizes profitability or net revenue of the vehicle. An added benefit may be the avoidance of waste of valuable fossil fuels and the resulting emissions of pollutants and greenhouse gases.

As opposed to the conventional or traditional display of fuel consumption relative to distance (mileage or miles/gallon or liters/100 km), the invention combines the costs and revenues of operation, gathers operational speed or distance per energy units such as fuel or electrical power consumption, and computes and displays optimum speed where net revenue is a maximum. Based on the display, operators can choose to operate the vehicle in ways that maximize the value of their time and minimize fuel consumption and resulting emissions of pollutants and greenhouse gases.

Gross revenue for a commercial vehicle is commonly expressed or contracted as a specified value of $/mile or kilometer; consequently the faster the vehicle operates the greater the revenue per hour. Expenses are then subtracted from gross revenue, such as fuel, taxes, insurance, maintenance, tolls, labor, etc.; leaving some worthwhile net revenue to the vehicle owner-operator. Since fuel costs and certain other costs increase as vehicle speed increases, the net revenue in dollars per hour as a function of vehicle speed will first increase at low speeds, rise to a maximum, and then begin to decline as speed continues to increase. The optimum speed to realize maximum revenue is calculated and displayed to the operator on a continuous basis.

### BRIEF DESCRIPTION OF THE DRAWINGS

FIG. 1 is a perspective view of the preferred embodiment of the invention;

FIG. 2 is a block diagram of electronic devices associated with the preferred embodiment;

FIGS. 3A-3E are flow charts of the program used by the microcomputer;

FIG. 4 is a chart of speed versus fuel flow rate for several trucks including a loaded Class 8 Heavy Truck-trailer; and

FIG. 5 is a chart of revenue as a function of speed for a fully-loaded Class 8 tractor-trailer, indicating the optimum speed in accordance with the invention.

### DETAILED DESCRIPTION OF THE INVENTION

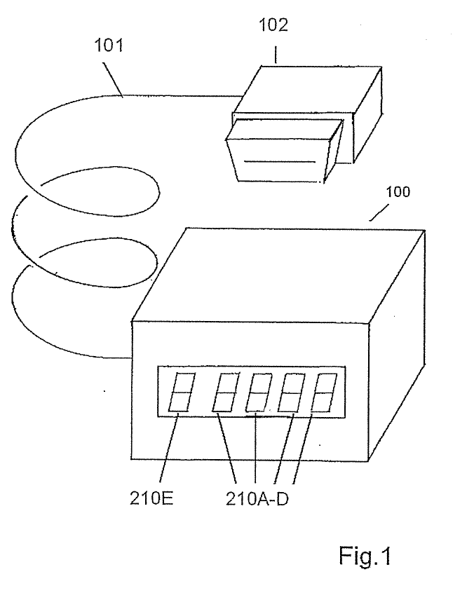

Embodiments of this invention provide improved information to guide operators of powered vehicles to operate the vehicle in ways to minimize cost, fuel consumption, waste and emissions. This invention applies to any powered vehicle traveling through a fluid including ground vehicles such as autos, trucks and trains; watercraft, and aircraft. The basic apparatus is shown in FIG. 1. Item 100 is a case or enclosure which may rest on, and be securely attached, to a dashboard, cockpit, wheelhouse, or command center of a vehicle, with the display 210 being in clear view of the operator. The housing 100 may measure approximately 4″ by 2″ by 3″, more or less.

An electrical cord 101 connects the electronics internal to the unit 100 to a data connector or data bus plug 102, configured to plug into the vehicle data bus jack or vehicle data bus receptacle typically located close to the operator station. For example, automobiles and light trucks sold in the U.S. and elsewhere since 1996 have an On Board Diagnostic II (OBDII) connector receptacle in conformance to SAE (Society of Automotive Engineers) Standard J1962. Heavy duty trucks and many other machines use a 6- or 9-pin receptacle in conformance with SAE Standard J1708 or J1939-21. Military aircraft and spacecraft may be in compliance with MIL-STD-1553. DC electric power to operate the machine may be provided from the data bus connection.

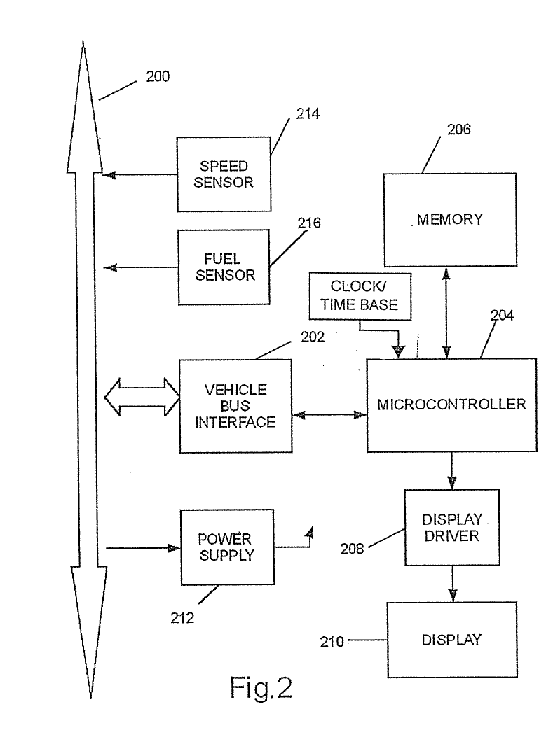

A block diagram of the electronics enclosed in FIG. 1 is shown in FIG. 2. Vehicle sensors such as a speed pickup 214 and fuel sensor 216 supply vehicle data to a vehicle data bus 200. OBD-Compliant vehicles use communications protocols defined in SAE Standards 1850, ISO Standards 9141 and 14230, and CAN (IS015765/SAE J2480). Heavy trucks and other vehicles use SAE Standard J1939-71 vehicle protocol. A data bus interface 202 serves as an interface to the vehicle data bus Item 200. Electronics of London, Ontario, Canada provides several styles of vehicle bus interface devices to match the various vehicle manufacturers' and SAE standard bus protocols, such as the ELM 320, 322, 327, and 329. Other suppliers such as ScanTool of Phoenix, Ariz. provide fully-assembled interfaces using the ELM device. A Control Area Network (CAN) Bus interface such as a Microchip MCP2551 manufactured by Microchip Electronics of Phoenix, Ariz., may also serve. The format of data available from the automobile OBD Bus is defined in SAE Standard J1979, otherwise known as Parameter Identifiers, or PIDs. Vehicles conforming to J1939 may routinely transmit standard data messages on the Data Bus identified as Parameter Group Numbers (PGNs), with individual data points identified as Suspect Parameter Numbers (SPNs).

The vehicle bus interface 202 communicates to a microcontroller 204 via, for example, a standard IEEE RS232 or other communications protocol. The microcontroller 204 is implemented with an 8-bit or more processor operating at a clock speed of 20 MHz or other speed, with 32 bytes more or less of random access memory (RAM). As one example, microcontroller 204 may be a Basic Stamp 2 from Parallax Inc. of Rockland, Calif., which includes a Microchip PIC 16C57c Microcontroller from MicroChip Electronics of Phoenix, Ariz. Memory 206 includes 2 kilobytes or more of electronically erasable read-only memory (EEROM) to store the program and data. Those skilled in the art may substitute a wide range of microprocessors and memory devices available from many manufacturers.

The microcontroller output is supplied to display driver 208, a multi-character LED display/lamp driver such as MC14489 manufactured by Motorola Incorporated of Phoenix, Ariz. The display 210 comprises five 7-segment 0.56″ light emitting diode (LED) displays arranged side-by side. The leftmost LED 210E shown in FIG. 1 is used for MODE or FUNCTION display, and is green or other color; the remaining LEDs 210A through 210D are red or other color, enabling displays from −999 to 9999 units. A decimal point is placed after one of the four digits to properly scale the output display. The MODE display Item 210E indicates “0” for Optimum Speed, “P” for fuel price, and “A” for revenue. An alternative embodiment utilizes a Vacuum Fluorescent Display (VFD) such as manufactured by Noritake of Japan to display up to 4 lines of 20 digits each; various other display options are possible. A separate regulated power supply 212 is supplied with 12 VDC from the vehicle bus connection and supplies power to the various devices.

System Operation

The operation of the system is under the control of a program stored in EEROM 206, written for the microcontroller 204, with additional functions being performed by the data bus interface 202 and the display driver 208. The following is a brief summary of the program and the steps performed:
1. The system determines and stores a table of vehicle average steady speed and average steady fuel flow rate.
2. The revenue and costs of operation of the vehicle as a function of speed are computed based on the stored fuel consumption data as well as cost and revenue data input by the operator.
3. The optimum speed for operation of the vehicle that maximizes net revenue or profitability is computed every second and displayed to the operator.

A light is illuminated to indicate the vehicle speed relative to optimum speed; blue or yellow if vehicle is significantly slower than optimum speed, green if vehicle speed is near optimum speed, and red if vehicle speed is significantly faster than optimum speed. Speed variations for color selection and actual colors are optional.

The program runs in a continuous loop. If commanded by the vehicle operator, the program may be interrupted to input and/or update fuel price and revenue or cost data. As commanded by the operator, the vehicle steady speed fuel characteristics can be cleared, continuously updated, or retained as-is.

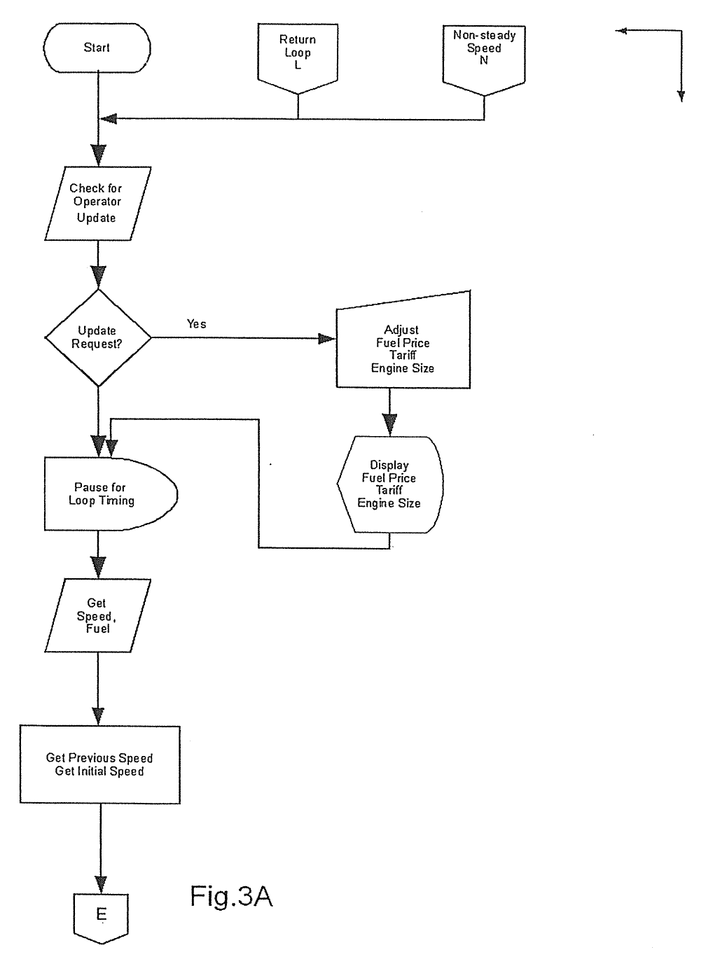

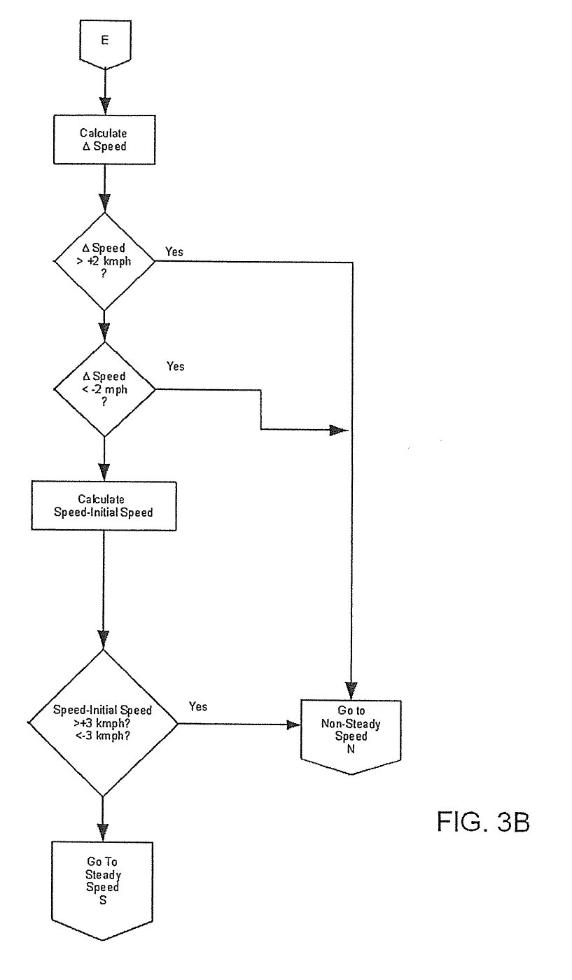

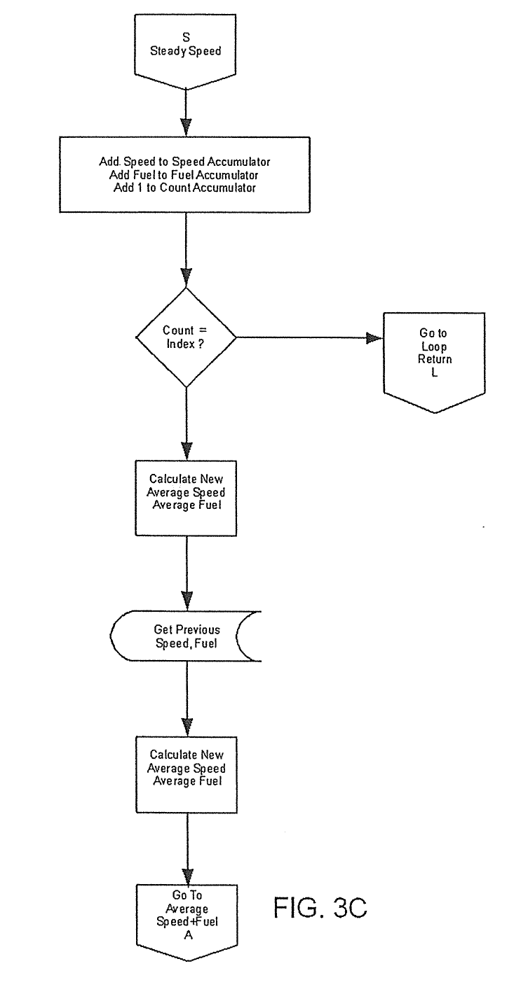

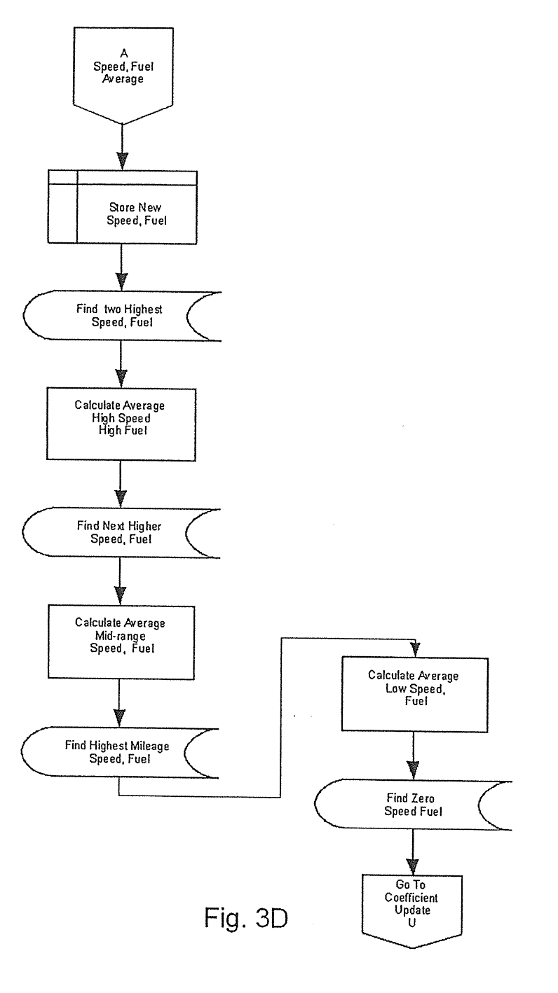

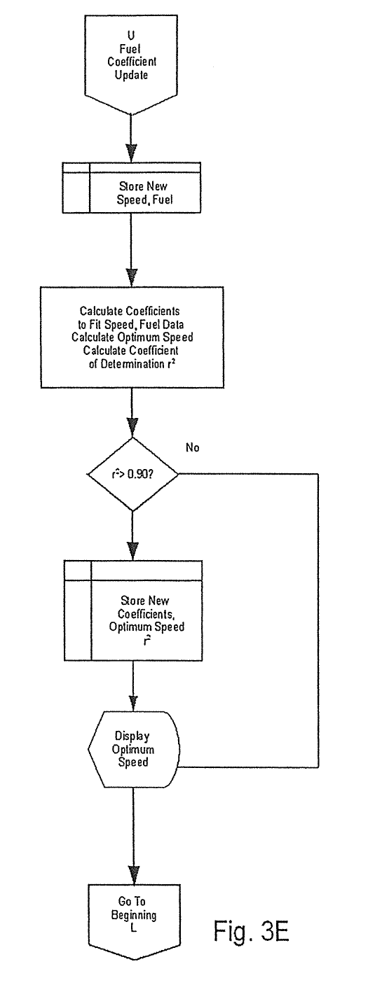

A more detailed explanation of the program can be seen in the Program Flow Chart, of FIGS. 3A-E and the following description. In the following discussion and graphics, speed is measured in kilometers per hour since those units are typically provided on the data bus, but may be converted to miles per hour or other units for operator display. Fuel flow rate of the vehicle is typically output to the data bus in liters per hour and converted by the microprocessor to gallons as the standard U.S. commercial measure. Time is measured in hours, another standard unit. The invention is not limited in terms of the units used. Speed of the vehicle is typically measured relative to a medium, such as ground speed for land vehicles, air speed for aircraft, and water speed for watercraft. An option is to utilize Global Positioning System (GPS) inputs for determining position and ground speed of the vehicle.

An additional function of the microprocessor is to compile the steady-speed fuel consumption characteristics of the vehicle. The fuel flow of a tractor-trailer or truck or other vehicle is dependent on the speed, but other variables as well. For instance, is the vehicle fully loaded to maximum weight, or traveling with a light cargo or empty? This affects the rolling resistance of the vehicle. The aerodynamics of the vehicle also affects fuel flow, such as a tall or short trailer or load and aerodynamic fairings added. Is the vehicle traveling with a headwind or tailwind? Is the vehicle going uphill or downhill?

The microprocessor operates to obtain the speed of the vehicle and engine data and compute the vehicle fuel flow once every second. Next, the speed is compared to the speed one second earlier to determine if the vehicle is operating at steady speed, accelerating, or decelerating. If the vehicle is sensed to be traveling at a steady speed, the vehicle is queried to determine if the engine coolant is at normal operating temperature and emissions controls are operating normally. If determined to be at steady speed, the speed value and fuel value are each added to separate accumulators, and a counter is incremented for the purpose of calculating an average speed and average fuel for a duration of approximately one minute or other speed-related duration.

At the accumulation of sufficient counts the average speed and fuel flow are calculated. This speed and fuel flow data pair are then used to update a table of speed and fuel data. If so, the speed and fuel flow is averaged over a period of 30 to 120 seconds. This new data is then weight-averaged with previous data and saved in a data table (Table I) in speed increments of 4 mph (6.4 kph) or other speed. Since this data table is updated frequently, it is representative of the steady-speed fuel consumption characteristics of the vehicle under current average conditions, including GVW, wind speed, air density, and grade. As conditions change such as adding or dropping a load, wind speed and/or direction changes, or the vehicle encounters a long grade, the speed-fuel table is constantly updated.

TABLE I
Speed and Fuel Data for Medium Duty Flat Bed Tow Truck

| No. | Speed mph * 2 | Fuel Flow gal/hr * 100 |
|---|---|---|
| 0 | 2 | 60 |
| 2 | 8 | 60 |
| 4 | 16 | |
| 6 | 24 | |
| 8 | 32 | |
| 10 | 40 | |
| 12 | 48 | |
| 14 | 56 | |
| 16 | 64 | |
| 18 | 76 | 270 |
| 20 | 80 | 280 |
| 22 | 92 | 400 |
| 24 | 100 | 470 |
| 26 | 106 | 540 |
| 28 | 112 | |
| 30 | 124 | 830 |
| 32 | 132 | 910 |
| 34 | 138 | 990 |

Another function of the microprocessor is to compute the relationship between speed and fuel consumption rate at any steady speed. One method for the mathematics of computation of steady speed fuel and optimum speed is explained in the following steps. In general, the drag forces of vehicles moving at constant speed consist of two components, first rolling resistance, and second aerodynamic and/or hydrodynamic drag. Aero drag and hydro drag both result from a body in motion in a fluid, hence follow the basic principles of physics and engineering of fluids. Consequently the following discussion applies to both media, but will be described simply as aero drag rolling resistance (RR) is relatively constant over the speed range of most land vehicles, dependent primarily on the Gross Vehicle Weight (GVW) and secondarily on speed. Thus:

Rolling Resistance Force=RRCoefficient1+RRCoefficient2*speed

Aerodynamic and hydrodynamic drag force is a function of air or water speed squared, almost negligible at low speed, but becoming very significant for most vehicles at typical operating speed. Aerodynamic drag force is also a linear function of air density, thus also varying with air temperature and elevation above sea level. The speed of the vehicle through air is the vector sum of ground speed and wind speed, so can vary significantly from the indicated ground speed depending on wind speed and direction. Thus:

Airspeed=ground speed+effective wind speed, and:

Airspeed2=(ground speed+effective wind speed)2

Since effective wind speed is usually unknown to a vehicle operator, assuming it to be relatively constant, aerodynamic drag can be expressed as a second order polynomial function of vehicle speed under any given wind condition.

Thus:

Aerodynamic Drag Force=airspeed2*aerodynamic drag constant

An additional force is encountered when climbing or descending grades, equal to the GVW times the percentage grade; this will be a positive or negative force depending on the direction of the grade. We will refer to this as gradeforce.

By definition the horsepower to propel a vehicle on a level roadway at constant speed is equal to speed times the sum of the forces or

Power=speed*Σdrag forces

Additional power losses occur in the powertrain such as axle bearings, differential gears, driveshafts, transmissions, and parasitic loads such as air conditioning, electrical power, etc. Consequently, engine power is greater than wheel power by some unknown amount and relationship. For typical prime movers such as gasoline Otto or Diesel engines, gas turbines, turbo jets or electric motors, the fuel or energy consumption rate is a complex function of prime mover revolutions per minute and power output, and other factors. This function can be well approximated to a first order by a “Willans Line,” a first constant times the power output plus a second constant. Thus, fuel flow in gallons per hour becomes:

Fuel Flow (gallons/hr)=Power*Coefficient3+Coefficient4

Combining this expression of fuel flow with the previous expression for power, it can be seen that the fuel or energy consumption in units of quantity/time of a vehicle at constant speed can be expressed by a 3rd order and lower orders function of vehicle speed and a complex set of coefficients. However, unless special tests are conducted to identify and measure each of these factors and coefficients independently, they remain unknown to the operator. However, fuel consumption rate can be simplified and expressed by a 3rd order, 4-term polynomial to a very high accuracy (Coefficients of Determination of 0.95 and higher), by the expression:

Fuel Flow (gallons/hr)=a₃*speed³+a₂*speed²+a₁*speed+a₀

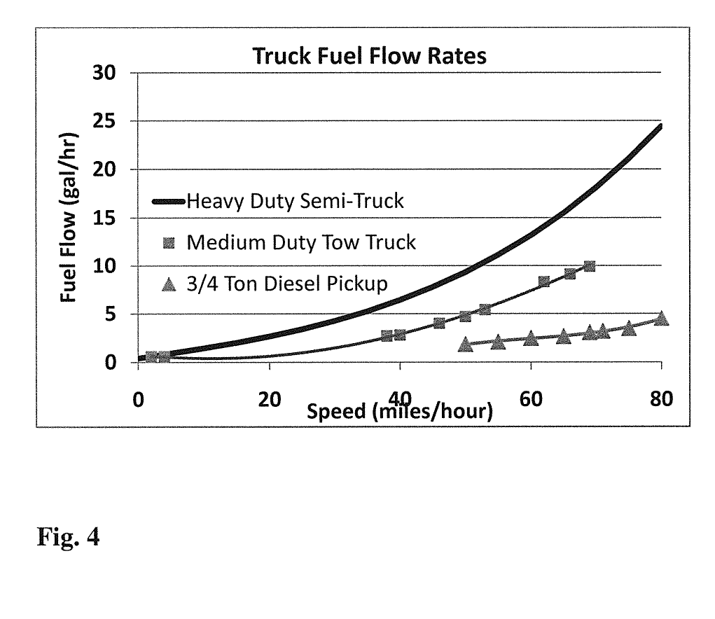

FIG. 4 provides some examples of steady speed Fuel Flow versus speed for several typical vehicles. This data is then be fit to the expression above to yield the curves connecting individual data points in FIG. 4.

The preferred method for developing coefficients a3 through a0 is curve-fitting of the speed-fuel data table example shown in Table I using standard statistical techniques of least-squares regression. Handbooks on statistics describe this method which is then implemented in the program. An alternative process consists of selecting four points along the curve and solving four equations with four unknowns using conventional algebra. One way to perform this process is as follows:

The lowest speed and fuel flow pair is selected, and coefficient a0 is set equal to that fuel flow.

The two highest speed and fuel flow pairs are selected and the average speed and average fuel of the two pairs are each calculated; the average speed is designated s2, and the average fuel is designated f2.

Two more pairs of speed and fuel are selected from the 45 to 60 mph range as available, the average speed and average fuel of the pairs are calculated; the average speed is designated s1 and the average fuel flow is designated f1.

The speed and fuel pair representing the highest fuel mileage rate are selected, and then averaged with one slower speed and fuel pair and one faster speed and fuel pair. This set is then designated s0 and f0.

A modified fuel flow for speed and fuel pair s3 and f3, s2 and f2, and s1 and f1 are calculated by subtracting a0 coefficient from each fuel flow, and dividing by the corresponding speed. These modified calculations of gallons of fuel per mile are designated g2, g1, and g0, reducing the problem set to three equations and three unknowns.

Coefficient a3 is calculated by the following formula:

a3=[(g2−g0)/(s2−s0)−(g1−g0)/(s1−s0)]/(s2−s1)

Coefficient a2 is calculated by the following formula:

a2=[(g2−g0)*(s0+s1)/(s2−s0)−(g1−g0)*(s0+s2)/(s1−s0)]/(s2−s1)

Coefficient a1 is calculated as:

a1=g2−a2*s2−a3*s22

Other expressions for coefficients are possible using conventional algebra. The coefficients are then saved in memory for use elsewhere in the program. Since the speed and fuel table is updated and coefficients are re-calculated every minute or two, the calculation of steady speed fuel is constantly adjusted to reflect changes in fuel consumption resulting from changes in GVW, vehicle cross section and aero drag, wind conditions, etc. Since these calculations are used to calculate optimum speed as shown below, the optimum speed adjusts constantly to the dynamics of the vehicle operating conditions.

As a land vehicle encounters the occasional typical undulations of the roadway while traveling at steady speed (such as on cruise control), the fuel flow will adjust to maintain steady speed either by action of operator or cruise control, increasing while going uphill and decreasing while going downhill. Consequently a fuel flow difference exists between the actual instantaneous fuel flow and calculated steady speed fuel flow. Since the grade represents an additional force to propel the vehicle, the horsepower required and hence the fuel flow is proportional to speed. This fuel difference is calculated as:

“Grade Fuel Coefficient”=(actual fuel flow−steady speed fuel flow)/speed

Similar to coefficient updates, the GradeFuel Coefficient is input to the optimum speed calculation as shown below, so optimum speed also reflects the dynamics of the elevation of the roadway.

The gross revenue of a commercial vehicle is usually contracted on a basis of weight and distance, for example tariff or cartage rate may be expressed in dollars of gross revenue per ton-mile. Thus for a given load, Tariff or Revenue is a function of dollars per mile. Certain categories of expenses may be a function of distance traveled and fairly independent of speed, such as maintenance, so are expressed as variable costs in dollars per mile, multiplied by speed, and subtracted from gross tariff. Other expenses may be thought of as fixed costs, or a constant amount per unit of time, such as interest, insurance, labor, etc. Since these costs are independent of speed, they are a constant cost per hour, so they are not input to the calculations to follow.

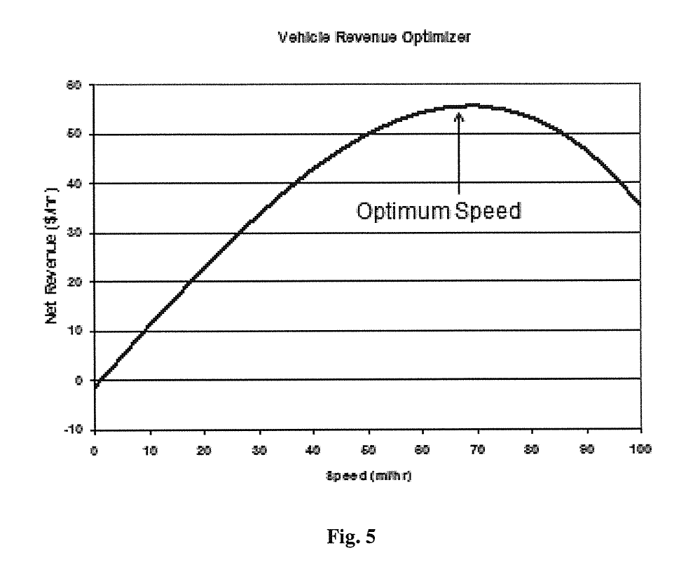

Next, net revenue in dollars per hour is calculated as a function of speed of the vehicle simply by calculating gross revenue per hour and subtracting fuel and other variable cost. Net revenue as a function of speed can be seen in FIG. 5 to start as a negative value at zero speed of the cost fuel of the engine or prime mover at idle. Net revenue then increases significantly with speed, reaches a maximum at optimum speed, and then decreases as speed continues to increase. In other words, at speeds below optimum speed the loss of revenue is greater than the savings in fuel flow, so net revenue per hour is less than optimum. As speed increases above optimum speed the cost of fuel to overcome the increase in aerodynamic or other variable drag is greater than the increase in revenue, and the net revenue per hour begins to decrease again.

Optimum speed is the speed at which net revenue or profit is a maximum and the slope of the graph or first derivative of the net revenue calculation reaches zero, as seen in FIG. 5. The optimum speed is calculated using the methods of Isaac Newton's differential calculus. The optimum speed calculation proceeds as follows: Revenue in dollars per hour is equal to speed in miles per hour times tariff in dollars per mile, or

Gross Revenue=Speed*Tariff or S*T

Fuel cost in dollars per hour is fuel flow rate in gallons per hour times fuel price in $/gal or,

Fuel ($/hr)=fuelprice*[a_{3*}S³+a_{2*}S²+(a₁₊GradeFuel Coefficient)_{*}S+a₀]

Net Revenue is equal to gross revenue less the cost of fuel, or

Net Revenue(R)=S*T−fuelprice*[a3*S3+a2*S2+(a1+GradeFuel Coefficient)*S+a₀]

Optimum Speed can be seen as the speed where net revenue is greatest, defined mathematically as the point where the slope of the function is zero. This point can be calculated using differential calculus, as follows: The slope is the first derivative of the revenue equation above, following the rules of differential calculus,

dR/dS=0=T−fuelprice*[3a3S2+2a2S+(a1+GradeFuel Coefficient)+0]

Re-writing,

dR/dS=3a₃*S²+2a₂*S+[a₁+GradeFuel Coefficient−T/fuelprice]=0

Thus the equation is in the classic quadratic form:

AX²+BX+C=0

And the solution is from the classic quadratic equation solution from. Algebra

X=[−B±√(B²−4AC)]/2A

Substituting,

Optimum Speed={[−2a₂+√[4a₂²−4*3a₃*(a₁+GradeFuel Coefficient−T/fuelprice)]}/(2*3a₃)

This equation is readily solved/computed by the microprocessor and displayed on the output device.

The price of fuel in dollars per gallon (or euros per liter, etc.) is stored in the memory 206, and may be updated by the vehicle operator via pushbuttons. Similarly, the revenue in dollars per kilometer or mile is stored in memory 206 and can also be updated by the owner or vehicle operator.

It is anticipated that the speed-fuel data may be cleared to zero for each loading of the vehicle, since the aero drag and rolling resistance are load-dependent. Consequently, a new set of speed-load data is collected before a calculation of optimum speed is carried out.

Fuel flow is also dependent on the grade, whether ascending or descending a hill or even a mountain. Consequently, optimum speed varies as modified by GradeFuel Coefficient.

If the vehicle is determined to be accelerating by comparing current speed to a previous speed, an “Acceleration Fuel Efficiency” is calculated and displayed as follows:

Acceleration Fuel Efficiency=(Fuel−Steady Speed Fuel)/delta Speed/Speed

This display can be used by the vehicle operator to identify and accelerate in a fuel-efficient manor.

In alternative embodiments, the invention may be included within a “trip computer” or driver information computer and display factory-installed in the vehicle, rather than as an add-on or aftermarket device as described previously. Such a device may further include telematics to communicate to a home office, for example.

Additional embodiments include data inputs to and algorithms (applications or “Apps”) within a “smart cell phone,” laptop or hand-held digital computer, global positioning satellite system (GPS)-based mapping and routing device. Use of wireless data transfer between the vehicle data bus and the machine, as well as the vehicle owner or corporate office using standard protocols is another option.

The apparatus may be based on analog electronics instead of digital signals and devices. First, a voltage or current or other signal may be derived from a vehicle speed sensor. This signal is input to an operational amplifier configured as a non-linear function generator, typically using diodes in a feedback loop. The device is calibrated to develop an output representative of the optimum speed shown in FIG. 5. The output of the non-linear function generator drives a display calibrated to indicate optimum speed in the selected units. One skilled in the art may design such a device to provide the multi-mode display of the digital version. Such a device may be similar or higher in cost to digital implementations.

Additional inputs to the system are required with hybrid gas-electric or hydraulic vehicles, some of which may be outside the scope of the OBD or other data bus standard. Steady speed operation is unaffected, although some additional fuel may be consumed on occasion to recharge or maintain the battery. The fuel consumed during acceleration includes the “fuel equivalent” of the power used by the propulsion motor(s). The detection of deceleration mode in a hybrid vehicle is more complex due to the inclusion of dynamic braking. The boundary between dynamic braking and friction braking is vehicle-specific, and may not be detectable by rate of deceleration alone. Consequently, implementation of the embodiment in a hybrid vehicle is more complex, but readily apparent to one skilled in the information and control systems associated with such vehicles.

Overall, the invention provides very useful information enabling the owner or operator of a powered vehicle to maximize the productivity of the vehicle and the roadway and obtain the best value of transportation and time usage for the fuel consumed. In the case of operating a vehicle as a business, the objective of most business owners is to serve customers and derive maximum return on the investment. For vehicles, that can be thought of simply as obtaining maximum net revenue. Since revenue and costs are speed-dependent, for any given operating condition there exists one speed that yields the maximum revenue, which is optimum speed, and this invention provides that information.

Operators of commercial vehicles have historically determined desired speed in arbitrary and capricious ways. For example, operation of vessels at maximum continuous rated engine power, trucks and cars at legal road speed limits, or recommendations from the “front office” are all possible. These processes all neglect the fundamental outcome of a commercial business; that is to maximize return on investment.

In accordance with this invention, apparatus displays and provides guidance to operators of powered vehicles to operate so as to maximize net revenue, defined as gross revenue minus costs. Additional benefits may include maximum equipment and labor utilization, and minimum energy consumption and waste and resultant emissions of pollutants and greenhouse gases.

The display of optimum speed yields maximum revenue for instant conditions, taking into consideration energy cost, vehicle operating and fixed costs and operator labor. This information may, at the operator's option, be supplied to the vehicle speed control for precise speed modulation.

The computed information may also be archived for later analysis. Many operating criteria such as rolling resistance and aerodynamic drag may be inferred and retrieved for later consideration and comparison. Using these data, performance of similar vehicles may be compared to determine which are more efficient in specific applications or conditions and what effect changes to vehicle configuration may have on desired performance.

An interesting and unexpected discovery is that optimum speed varies significantly with travel conditions. For example, when encountering a headwind, the system typically recommends a deceleration to a lower speed as a result of greater aerodynamic drag. Accordingly, a tailwind would enable a faster optimum speed, saving both time and fuel. Upgrades and downgrades have similar effects. Gross Vehicle Weight (GVW) may vary with each segment of a trip, and vehicle aerodynamics may be different for each vehicle in a fleet and load, both impacting optimum speed. It was discovered that such variables have an effect on optimum speed, leading to the conclusion that a fixed speed is non-optimum and the machine most effectively took such conditions into consideration during calculations and provided an accurate speed modification direction to the operator. Consequently, the calculation of a recommended maximum speed to maximize revenue or other criteria based on assumed conditions by a proprietary method does not reflect the dynamics of the road, hence does not yield optimum except under ideal conditions.

Another interesting and unexpected result is that observation and graphing of fuel consumption versus speed provides a reasonably accurate representation of rolling resistance and aerodynamic drag. This may be a valuable tool for comparison of similar vehicles, the efficacy of aerodynamic modifications and suitability for specific applications. For example, two similar vehicles from different manufacturers, with similar loads, can be compared directly for fuel and aerodynamic efficiency at multiple operating speeds, giving the operator valuable data for future vehicle purchases. These data also provide useful information on the effect of aerodynamic modifications including spoilers, splitters, air dams and general vehicle shape modifications. Additionally, truck operators may determine which tractor-trailer combinations are most efficient aerodynamically.

1. A system for determining optimum vehicle speed, comprising:
an input for receiving vehicle speed information and engine data;
a memory; and
a processor operative to perform the following functions:
a) receive the vehicle speed information and engine data, and automatically compute and store in the memory, steady-speed fuel consumption characteristics of the vehicle,
b) compute vehicle revenue and cost of operation as a function of the steady-speed fuel consumption characteristics, and
c) compute the optimum speed associated with the operation of the vehicle, the optimum speed being defined as the speed which maximizes net revenue or profitability.

2. The system of claim 1, further including a display for displaying information regarding the optimum speed to a vehicle operator.

3. The system of claim 1, wherein the processor is further operative to:
obtain the vehicle speed information and engine data on a regular and periodic basis,
compare the speed information to previously stored speed information to determine if the vehicle is operating at steady speed, accelerating, or decelerating, and
if the vehicle is operating at steady speed, compute the average speed of the vehicle and fuel flow.

4. The system of claim 3, wherein the processor is further operative to deter wine if the engine coolant is at normal operating temperature and emissions controls are operating normally.

5. The system of claim 3, wherein the processor is further operative to compute the average speed and fuel flow of the vehicle and store that average speed and fuel flow in a data table of speed and incremental fuel flow rate.

6. The system of claim 3, wherein the processor is further operative to compute the fuel flow of the vehicle at steady speed and level road in accordance with the expression:
steady speed fuel flow=a_{3*}S³+a_{2*}S²+a_{1*}S+a₀
where coefficients a3 through a0 are developed by standard statistical curve-fitting techniques of least-squares regression, or by selecting four points along a curve and solving four equations with four unknowns.

7. The system of claim 3, wherein the processor is further operative to compute the instantaneous fuel flow for climbing or descending a grade according to the expression:
gradefuel coefficient=(actual fuel flow−steady speed fuel flow)/speed

8. The system of claim 3, further including:
an input for receiving the current price of fuel; and
wherein the processor is further operative to compute the cost of fuel in dollars per hour by multiplying fuel flow by fuel price.

9. The system of claim 3, further including an input for receiving a tariff of revenue, and wherein the processor is further operative to compute gross revenue using the expression:
gross revenue=speed*tariff(S*T)

10. The system of claim 3, wherein the processor is further operative to compute fuel cost over time using the expression:
fuel ($/hr)=fuelprice*[a_{3*}S³+a_{2*}S²+(a₁gradefuel coefficient)_{*}S+a₀]
where coefficients a3 through a0 are developed by standard statistical curve-fitting techniques of least-squares regression, or by selecting four points along a curve and solving four equations with four unknowns.

11. The system of claim 3, wherein the processor is further operative to compute net revenue using the expression:
net revenue(R)=S*T−fuelprice*[a_{3*}S³+a_{2*}S²+(a₁+gradefuel coefficient)_{*}S+a₀]
where coefficients a3 through a0 are developed by standard statistical curve-fitting techniques of least-squares regression, or by selecting four points along a curve and solving four equations with four unknowns.

12. The system of claim 3, wherein the processor is further operative to compute optimum speed using the expression:
optimum speed={[−2a₂+√[4a₂²−4*3a₃*(a₁+gradefuel coefficient−T/fuelprice)]}/(2*3a₃)
where coefficients a3 through a0 are developed by standard statistical curve-fitting techniques of least-squares regression, or by selecting four points along a curve and solving four equations with four unknowns.

13. The system of claim 3, wherein the processor is further operative to determine if the vehicle is accelerating by comparing present speed to a previous speed and compute acceleration fuel efficiency using the expression:
acceleration fuel efficiency=(fuel−steady speed fuel)/(delta speed)/speed.

14. A method of determining optimum vehicle speed, comprising the steps of:
receive vehicle speed information and engine data at a programmed processor;
automatically compute and store steady-speed fuel consumption characteristics of the vehicle,
automatically compute vehicle revenue and cost of operation as a function of the steady-speed fuel consumption characteristics,
automatically compute the optimum speed associated with the operation of the vehicle, the optimum speed being defined as the speed which maximizes net revenue or profitability; and
display information regarding the optimum speed to a vehicle operator.

15. The method of claim 14, further including the steps of:
obtaining the vehicle speed information and engine data on a regular and periodic basis,
comparing the speed information to previously stored speed information to determine if the vehicle is operating at steady speed, accelerating, or decelerating, and
if the vehicle is operating at steady speed, automatically compute the average speed of the vehicle and fuel flow.

16. The method of claim 14, further including the step of determining if the engine coolant is at normal operating temperature and emissions controls are operating normally.

17. The method of claim 14, further including the step of automatically computing the average speed and fuel flow of the vehicle and store that average speed and fuel flow in a data table of speed and incremental fuel flow rate.

18. The method of claim 14, further including the step of automatically computing the fuel flow of the vehicle at steady speed and level road in accordance with the expression:
steady speed fuel flow=a_{3*}S³+a_{2*}S²+a_{1*}S+a₀
where coefficients a3 through a0 are developed by standard statistical curve-fitting techniques of least-squares regression, or by selecting four points along a curve and solving four equations with four unknowns.

19. The method of claim 14, further including the step of automatically computing the instantaneous fuel flow for climbing or descending a grade according to the expression:
gradefuel coefficient=(actual fuel flow−steady speed Fuel flow)/speed

20. The method of claim 14, further including the step of automatically computing the cost of fuel in dollars per hour by multiplying fuel flow by fuel price.

21. The method of claim 14, further including the step of automatically computing gross revenue using the expression:
gross revenue=speed*tariff(S*T)

22. The method of claim 14, further including the step of automatically computing fuel cost over time using the expression:
fuel ($/hr)=fuelprice*[a_{3*}S³+a_{2*}S²+(a₁gradefuel coefficient)_{*}S+a₀]
where coefficients a3 through a0 are developed by standard statistical curve-fitting techniques of least-squares regression, or by selecting four points along a curve and solving four equations with four unknowns.

23. The method of claim 14, further including the step of automatically computing net revenue using the expression:
net revenue(R)=S*T−fuelprice*[a_{3*}S³+a_{2*}S²+(a₁+gradefuel coefficient)_{*}S+a₀]
where coefficients a3 through a0 are developed by standard statistical curve-fitting techniques of least-squares regression, or by selecting four points along a curve and solving four equations with four unknowns.

24. The method of claim 14, further including the step of automatically computing optimum speed using the expression:
optimum speed={[−2a₂+√[4a₂²−4*3a₃*(a₁+gradefuel coefficient−T/fuelprice)]}/(2*3a₃)
where coefficients a3 through a0 are developed by standard statistical curve-fitting techniques of least-squares regression, or by selecting four points along a curve and solving four equations with four unknowns.

25. The method of claim 14, further including the step of automatically determining if the vehicle is accelerating by comparing present speed to a previous speed and compute acceleration fuel efficiency using the expression:
acceleration fuel efficiency=(fuel−steady speed fuel)/(delta speed)/speed
